(19) United States
(12) Patent Application Publication
(10) Pub. No.: US 2010/0154951 A1
(43) Pub. Date: Jun. 24, 2010

(54) PNEUMATIC TIRE

(75) Inventor: Youichi Honbou, Iruma-shi (JP)

Correspondence Address: SUGHRUE MION, PLLC, 2100 PENNSYLVANIA AVENUE, N.W., SUITE 800, WASHINGTON, DC, 20037, US

(73) Assignee: BRIDGESTONE CORPORATION, Chuo-ku, Tokyo (JP)

(21) Appl. No.: 12/161,115

(22) PCT Filed: Jan. 17, 2007
(86) PCT No.: PCT/JP2007/050584

§ 371 Date: Jun. 26, 2009

(30) Foreign Application Priority Data
Jan. 17, 2006 (JP) 2006-008705

(51) Int. Cl. B60C 11/04; B60C 11/12

(52) U.S. Cl. 152/209.18

(57) ABSTRACT

A plurality of ribs (9, 11 and 18) extending in a tire circumferential direction (C) are defined in a tire width direction (W) by a plurality of circumferential main grooves (5 and 7). In two or more second ribs (11), a plurality of sipes (19) are formed so as to be spaced apart in the tire circumferential direction (C) and to cut across the ribs. By the plurality of sipes (19), the two or more second ribs (11) are divided into a plurality of divided ribs (21). All intersection angle portions on one side in the tire circumferential direction (C) in each of the divided ribs (21) are formed to have obtuse angles. Only on one side in the tire circumferential direction (C) in each of the divided ribs (21), a runner groove (23) communicated with the corresponding sips (19) is formed so as to cut across the second rib (11).

### TECHNICAL FIELD

The present invention relates to a pneumatic tire achieving a good balance between wet performance and uneven wear resistance.

### BACKGROUND ART

With reference to FIGS. 1 and 2, a conventional technique will be described.

Here, FIG. 1 is a planar development view of a part of a tread in a pneumatic tire according to a conventional embodiment. FIG. 2 is a view along the line II-II in FIG. 1. Note that, in the figure, “L” indicates a left direction and “R” indicates a right direction.

As shown in FIG. 1, in a center portion of a tread 103 in a pneumatic tire 101, a pair of center circumferential main grooves 105 extending in a tire circumferential direction C are provided so as to sandwich a tire equator line S therebetween. Moreover, in shoulder portions of the tread 103, a pair of shoulder circumferential main grooves 107 extending in the tire circumferential direction C are provided so as to sandwich the pair of center circumferential main grooves 105 therebetween.

A center rib 109 extending in the tire circumferential direction C is defined by the pair of center circumferential main grooves 105. Moreover, second ribs 111 extending in the tire circumferential direction C are defined each by the center circumferential main groove 105 and the shoulder circumferential main groove 107 adjacent to each other. Furthermore, shoulder ribs 113 extending in the tire circumferential direction C are defined by the shoulder circumferential main grooves 107 and tread edges E.

Moreover, in the pair of second ribs 111, a plurality of sipes 115 are formed in a traversing manner so as to be spaced apart in the tire circumferential direction C. By the plurality of sipes, the pair of second ribs 111 are divided into a plurality of divided ribs 117. Moreover, in the pair of second ribs 111, a plurality of runner grooves 119 communicated with the sipes 115 are formed in a traversing manner so as to be spaced apart in the circumferential direction. As shown in FIG. 2, a center 119c of each of the runner grooves 119 is positioned on the corresponding ripe 115.

Note that a conventional technique related to the present invention is described in Patent Document 1.

### Patent Document 1: Japanese Patent Application Laid-Open NO. 2000-168817

### DISCLOSURE OF INVENTION

In the above example, the plurality of sipes 115 and the plurality of runner grooves 119 are formed so as to cut across the second ribs 111. Thus, an edge effect (an effect of cutting water films) and drainage can be enhanced. However, as described above, each of the pair of second ribs 111 is divided into the plurality of divided ribs 117. Thus, due to shear deformation in kicking out, uneven wear such as heel-and-toe (hereinafter abbreviated as H&T) wear is likely to occur. Therefore, in the conventional and general pneumatic tire 101, it is very difficult to improve uneven wear resistance while improving wet performance.

An object of the present invention is to solve the foregoing problems and to provide a pneumatic tire achieving a good balance between wet performance and uneven wear resistance.

As an aspect of the present invention, there is provided a pneumatic tire including a tread extending in a tire circumferential direction. The tread has a plurality of ribs defined in a tire width direction by a plurality of circumferential main grooves formed so as to extend continuously in the tire circumferential direction and a plurality of divided ribs divided in at least two of the plurality of ribs by a plurality of sipes formed in the at least two of the ribs so as to be spaced apart in the tire circumferential direction and to cut across the ribs. Moreover, only on one side in the tire circumferential direction in each of the divided ribs, a runner groove with the corresponding sipe is formed so as to out across the rib. Furthermore, all intersection angle portions on one side in the tire circumferential direction in each of the divided ribs have obtuse angles.

According to the aspect of the present invention, the plurality of sipes are formed in at least two or more of the ribs so as to cut across the ribs. Moreover, in each of the divided ribs, the runner groove communicated with the sipe is formed so as to cut across the rib. Therefore, an edge effect (an effect of cutting water films) and drainage can be enhanced.

All the intersection angle portions on one side the tire circumferential direction in each of the divided ribs in are set to have the obtuse angles. Therefore, even if the runner groove is formed on one side in the tire circumferential direction in each of the divided ribs, circumferential rigidity on one side in the tire circumferential direction (rigidity in the tire circumferential direction) in each of the divided ribs can be sufficiently maintained. Moreover, the runner groove is formed only on one side in the tire circumferential direction in each of the divided ribs. In other words, the runner groove is not formed on the other side in the tire circumferential direction in each of the divided ribs. Thus, reduction in the circumferential rigidity on the other side in the tire circumferential direction in each of the divided ribs can be suppressed. Accordingly; the circumferential rigidity of the divided rib is sufficiently maintained so that uneven wear such as H&T wear can be made less likely to occur.

In addition to the above configuration, among all the intersection angle portions, angles of the intersection angle portions with respect to rib edges may be set to 110° to 125°.

Here, the reason why the angles of the intersection angle portions with respect to the rib edges are set to not less than 110° is because, if the angles of the intersection angle portions with respect to the rib edges are less than 110°, edge components in the tire circumferential direction cannot be sufficiently secured. Moreover, the reason why the angles of the intersection angle portions with respect to the rib edges are set to not more than 125° is because, if the angles of the intersection angle portions with respect to the rib edges exceed 125°, reduction in circumferential rigidity on the other side of the divided rib in the tire circumferential direction cannot be sufficiently suppressed.

In addition to the above configuration, each of the sipes may have an odd number of bent portions in the middle of crossing the rib.

Furthermore, in addition to the above configuration, a depth of the runner groove may be set to 2 mm to 4 mm and a width of the runner groove may be set to 2 mm to 5 mm.

Here, the reason why the depth and width of the runner groove are set to not less than 2 mm is because, if the depth and width of the runner groove are less than 2 mm, an edge effect and drainage cannot be sufficiently enhanced. Moreover, the reason why the depth of the runner groove is set to not more than 4 mm, is because, if the depth of the runner groove exceeds 4 mm, the circumferential rigidity of the divided rib cannot be maintained more sufficiently. Furthermore, the reason why the width of the runner groove is set to not more than 5 mm is because, if the width of the runner groove exceeds 5 mm, binding force between the divided ribs adjacent to each other is lowered and thus the circumferential rigidity of the divided rib cannot be maintained more sufficiently.

In addition to the above configuration, a depth of a rib edge side portion in the sipe may be set smaller than a depth of a rib center portion.

According to the above configuration, since the depth of the rib edge side portion in the sips is set smaller than the depth of the rib center portion, circumferential rigidity of the rib edge side portion in the divided rib is sufficiently secured so that the circumferential rigidity of the divided rib can be maintained more sufficiently.

Furthermore, in addition to the above configuration, the depth of the rib edge side portion in the sips may be set larger within a range of 3 mm to 8 mm than the depth of the runner groove.

Here, the reason why a difference in depth between the rib edge side portion in the sips and the runner groove is set to not less than 3 mm is because the edge effect and drainage cannot be sufficiently secured in the middle stage of wear and thereafter, unless the difference in depth between the rib edge side portion in the sips and the runner groove reaches 3 mm. Moreover, the reason why the difference in depth between the rib edge side portion in the sipe and the runner groove is set to not more than 8 mm is because, if the difference in depth between the rib edge side portion in the sips and the runner groove exceeds 8 mm, circumferential rigidity of the rib edge aide portion in the divided rib cannot be sufficiently secured and thus the circumferential rigidity of the divided rib cannot be maintained more sufficiently.

According to the above configuration, the circumferential rigidity of the divided rib is sufficiently maintained so that the uneven wear such as H&T wear can be made less likely to occur, while sufficiently enhancing the edge effect and the drainage. Thus, in the pneumatic tire, it is possible to improve uneven wear resistance while improving wet performance. In other words, a good balance between the wet performance and the uneven wear resistance can be easily achieved.

### BRIEF DESCRIPTION OF DRAWINGS

FIG. 1 is a planar development view of a part of a tread in a pneumatic tire according to a conventional embodiment.

FIG. 2 is a view along the line FIG. 1.

FIG. 3 is a planar development view of a part of a tread in a pneumatic tire according to an embodiment of the present invention.

FIG. 4 is a view along the line VI-VI in FIG. 3.

FIG. 5 is a view along the line V-V in FIG. 3.

FIG. 6 is a view showing another form of sipes and runner grooves according to the embodiment of the present invention.

### BEST MODE FOR CARRYING OUT THE INVENTION

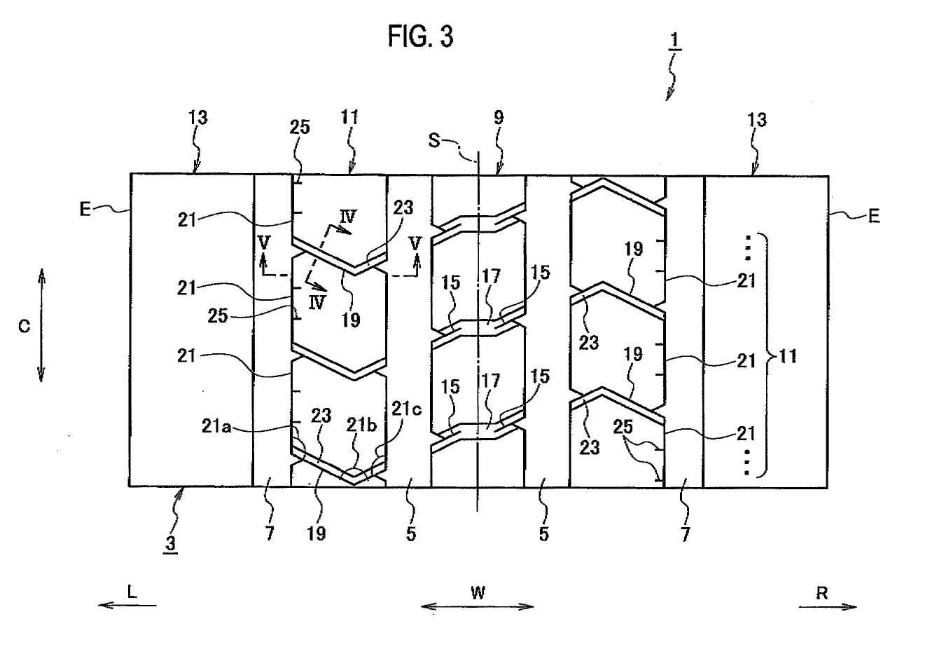

With reference to FIGS. 3 to 6, an embodiment of the present invention will be described.

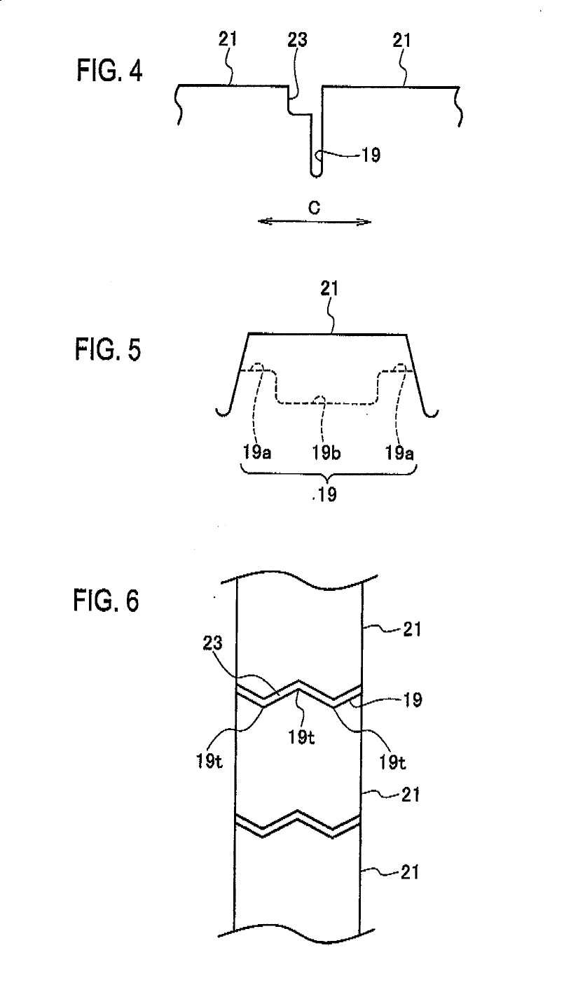

Here, FIG. 3 is a planar development view of a part of a tread in a pneumatic tire according to an embodiment of the present invention. FIG. 4 is a view along the line VI-VI in FIG. 3. FIG. 5 is a view along the line V-V in FIG. 3. FIG. 6 is a view showing another form of sipes and runner grooves according to the embodiment of the present invention. Note that, in the figure, “L” indicates a left direction and “R” indicates a right direction.

As shown in FIG. 3, in a center portion of a tread 3 in a pneumatic tire 1 according to the embodiment of the present invention, a pair of center circumferential main grooves 5 continuously extending in a tire circumferential direction C are provided so as to sandwich a tire equator line S therebetween. Moreover, in shoulder portions of the tread 3, a pair of shoulder circumferential main grooves 7 continuously extending in the tire circumferential direction C are provided so as to sandwich the pair of center circumferential main grooves 5 therebetween.

A center rib 9 extending in the tire circumferential direction C is defined by the pair of center circumferential main grooves 5. Moreover, second ribs 11 extending in the tire circumferential direction C are defined by the center circumferential main grooves 5 and the shoulder circumferential main grooves 7 adjacent to each other. Furthermore, shoulder ribs 13 extending in the tire circumferential direction C are defined by the shoulder circumferential main grooves 7 and tread edges E.

At left and right rib edges of the center rib 9, a plurality of short sipes 15 are formed so as to be spaced apart in the tire circumferential direction C. Moreover, in the center rib 9, a plurality of runner grooves 17 communicated with the left and right short sipes 15 corresponding thereto are formed so as to be spaced apart and to cut across the center rib. Furthermore, as shown in FIG. 5, a depth of a rib edge side portion 19a in a sipe 19 is smaller than a depth of a rib center portion 19b.

As shown in FIG. 8, in the pair of second ribs 11, a plurality of the sipes 19 are formed in a traversing manner so as to be spaced apart in the tire circumferential direction C. By the plurality of sipes 19, the pair of second ribs 11 are divided into a plurality of divided ribs 21. Moreover, each of the sipes 19 has an odd number of (1 in FIG. 8) bent portions 19t in the middle of crossing the second rib 11 so as to set obtuse angles in all intersection angle portions 21a to 21c on one side in the tire circumferential direction C in each of the divided ribs 21. Note that the number of the bent portions 19t may be 8 as shown in FIG. 6 as long as the number thereof is an odd number.

Moreover, as shown in FIGS. 3 and 6, only on one side in the tire circumferential direction C in each of the divided ribs 21, a runner groove 23 communicated with the corresponding sips 19 is formed so as to cut across the second rib 11.

As shown in FIG. 3, at a rib edge on the tread edge E side of each of the pair of second ribs 11, a plurality of multi-sipes 25 are formed so as to be spaced apart. Here, the multi-sipes mean sipes formed at sips intervals of 2 mm to 20 mm so as to have a length of 1 mm to 5 mm.

More specific configurations of the sips 19, the divided rib 21, the runner groove 23 and the like will be described.

Among all the intersection angle portions 21a to 21c having obtuse angles in the divided rib 21, each of the intersection angle portions 21a and 21c with respect to the rib edges is set to have an angle of 110° to 125°.

Here, the reason why the angles of the intersection angle portions 21a and 21c with respect to the rib edges are set to not less than 110° is because, if the angles of the intersection angle portions 21a and 21c with respect to the rib edges are less than 110°, edge components in the tire circumferential direction C cannot be sufficiently secured. Moreover, the reason why the angles of the intersection angle portions 21a and 21c with respect to the rib edges are set to not more than 125° is because, if the angles of the intersection angle portions 21a and 21c with respect to the rib edges exceed 125°, reduction in circumferential rigidity on the other side in the tire circumferential direction C in the divided rib 21 cannot be sufficiently suppressed.

The runner groove 28 is set to have a depth of 2 mm to 4 mm and a width of 2 mm to 5 mm.

Here, the reason why the depth and width of the runner groove 23 are set to not less than 2 mm is because, if the depth and width of the runner groove 23 are less than 2 mm, an edge effect and drainage cannot be sufficiently enhanced. Moreover, the reason why the depth of the runner groove 23 is set to not more than 4 mm is because, if the depth of the runner groove 23 exceeds 4 mm, the circumferential rigidity of the divided rib 21 cannot be maintained more sufficiently. Furthermore, the reason why the width of the runner groove 23 is set to not more than 5 mm is because, if the width of the runner groove 23 exceeds 5 mm, binding force between the divided ribs 21 adjacent to each other is lowered and thus the circumferential rigidity of the divided rib 21 cannot be maintained more sufficiently.

The depth of the rib edge side portion 19a in the sipe 19 is set larger within a range of 3 mm to 8 mm than the depth of the runner groove 23.

Here, the reason why a difference in depth between the rib edge side portion 19a in the sips 19 and the runner groove 23 is set to not less than 3 mm is because the edge effect and drainage cannot be sufficiently secured in the middle stage of wear and thereafter, unless the difference in depth between the rib edge side portion 19a in the sipe 19 and the runner groove 23 reaches 3 mm. Moreover, the reason why the difference in depth between the rib edge side portion 19a in the sipe 19 and the runner groove 23 is set to not more than 8 mm is because, if the difference in depth between the rib edge side portion 19a in the sipe 19 and the runner groove 23 exceeds 8 mm, circumferential rigidity of the rib edge side portion in the divided rib 21 cannot be sufficiently secured and thus the circumferential rigidity of the divided rib 21 cannot be maintained more sufficiently.

Next, operations and effects according to the embodiment of the present invention will be described.

In the pair of second ribs 11, the plurality of sipes 19 are formed so as to cut across the second ribs. Moreover, in each of the divided ribs 21, the runner grooves 23 communicated with the sipes 19 are formed so as to cut across the second ribs 11. Thus, the edge effect (an effect of cutting water films) and the drainage can be enhanced.

All the intersection angle portions 21a to 21c on one side in the tire circumferential direction C in each of the divided ribs 21 are set to have the obtuse angles. Therefore, even if the runner groove 23 is formed on one side in the tire circumferential direction C in each of the divided ribs 21, circumferential rigidity on one side in the tire circumferential direction C in each of the divided ribs 21 (rigidity in the tire circumferential direction C) can be sufficiently maintained. Moreover, the runner groove 28 is formed only on one side in the tire circumferential direction C in each of the divided ribs 21. In other words, the runner groove 23 is not formed on the other side in the tire circumferential direction C in each of the divided ribs 21. Thus, reduction in the circumferential rigidity on the other side in the tire circumferential direction C in each of the divided ribs 21 can be suppressed. Accordingly, the circumferential rigidity of the divided rib 21 is sufficiently maintained so that uneven wear such as H&T wear can be made less likely to occur.

Particularly, the depth of the rib edge side portion 19a in the sips 19 is set smaller than the depth of the rib center portion 19b. Moreover, the runner groove 23 is set to have the depth of 2 mm to 4 mm and the width of 2 mm to 5 mm. Thus, the circumferential rigidity of the divided rib 21 can be more sufficiently maintained while sufficiently enhancing the edge effect and drainage. Moreover, the depth of the rib edge side portion 19a in the sips 19 is set larger within the range of 3 mm to 8 mm than the depth of the runner groove 23. Thus, the edge effect and drainage can be sufficiently secured in the middle stage of wear and thereafter.

The angles of the intersection angle portions 21a and 21c with respect to the rib edges are set to 110° to 125°. Thus, reduction in the circumferential rigidity on the other side in the tire circumferential direction C in the divided rib 21 is sufficiently maintained so that the edge components in the tire circumferential direction C can be sufficiently secured.

As described above, according to the embodiment of the present invention, the circumferential rigidity of the divided rib is sufficiently maintained so that the uneven wear such as H&T wear can be made less likely to occur, while sufficiently enhancing the edge effect and the drainage. Thus, in the pneumatic tire, it is possible to easily improve uneven wear resistance while improving wet performance. In other words, a good balance between the wet performance and the uneven wear resistance can be easily achieved. Particularly, since the edge component in the tire circumferential direction C is sufficiently secured, the wet performance at the time of turning.

Note that the present invention is not limited to the above description of the embodiment but can be implemented in various other modes. Moreover, a range of rights encompassed by the present invention is not limited to the above embodiment.

### Examples

Examples of the present invention will be described.

### (1) Test Method

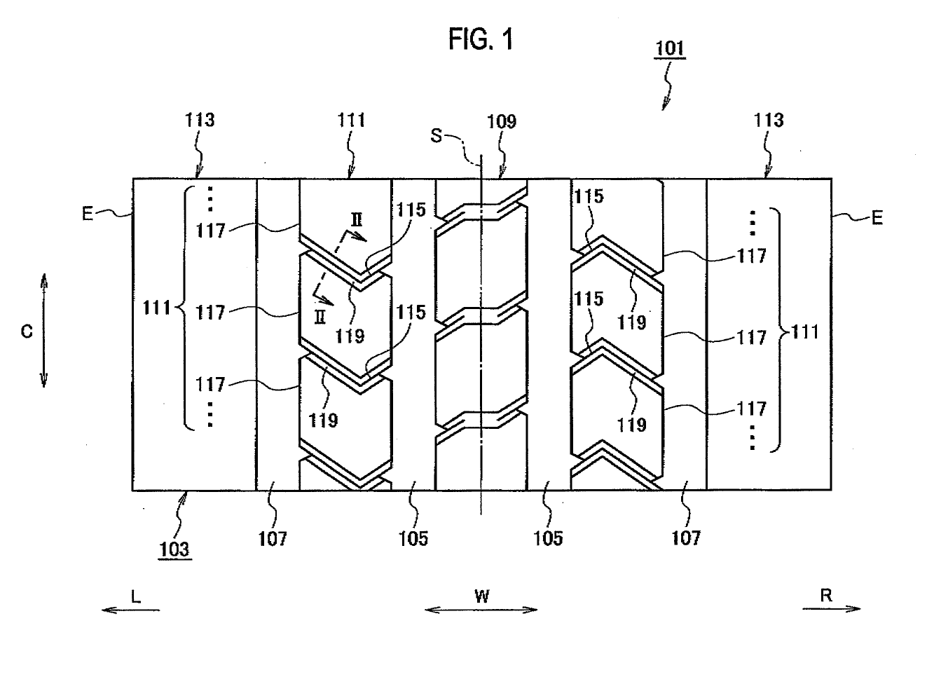

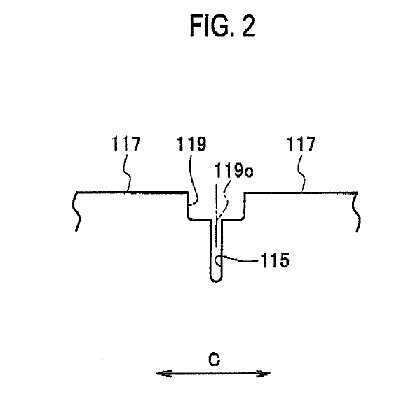

As Examples 1 to 6, products of the pneumatic tire 1 according to the embodiment shown in FIG. 3 are used, and each product is set to have a pattern configuration as shown in Table 1 for each specification. Moreover, as Comparative Example 1, a product of the pneumatic tire 101 according to the embodiment shown in FIG. 1 is used and similarly set to have a pattern configuration as shown in Table 1.

Thereafter, for each of Examples 1 to 6 and Comparative Example 1, (a) an uneven wear (H&T step) measuring test and (b) a feeling evaluation test having combined turning and braking tests on a wet road surface are conducted. Note that test conditions are as follows.

### (a) Uneven Wear (H&T Step) Measuring Test

Size of tire used: 315/80R22.5
Size of rim used: 9.00×22.5
Set inner pressure of tire: 825 kPa
Vehicle type: 4×2 tractor, pulling three-axle trailer
Mounting position: Front wheel
Test load: 3550 kgf
Test speed: 80 km/h

An H&T step amount is measured after running on a 3.8-km-circumference test course for 1 month, 7 hours a day, under the above conditions.

### (b) Feeling Evaluation on Wet Road Surface

Size of tire used: 315/80R22.5
Size of rim used 9.00×22.5
Set inner pressure of tire: 825 kPa
Vehicle type: 4×2 tractor, pulling three-axle trailer
Mounting position: Front wheel
Test load=3550 kgf

Evaluation is made on feelings when: turning is performed on a wet road surface with a water depth of 2 mm at a fixed speed of 30 km/h; and full braking is performed on a wet road surface with a water depth of 2 mm from an initial speed of 30 km/h.

### (2) Test Results

(a) A step amount (heel-and-toe step amount) between a kicking side (heel side) and a stepping side (toe side) of the divided rib in the second rib is evaluated with an average of the entire circumference. Table 1 below shows H&T step absolute amounts of Examples 1 to 6 and Comparative Example 1, Note that, if the H&T step is not more than 2.1 mm, it is determined that there is no problem with marketability.

(b) Feeling Evaluation on Wet Road Surface

In Table 1 below, evaluations on Examples 2 to 6 and Comparative Example 1 are indicated by indices while setting a feeling evaluation index of Example 1 to 100. Note that Table 1 shows that the larger the feeling evaluation index is the more stable the behavior in turning on the wet road surface is and the more safely the tire can be stopped.

TABLE 1

| | Example | Example | Example | Example | Example | Example | Comparative |
|---|---|---|---|---|---|---|---|
| | 1 | 2 | 3 | 4 | 5 | 6 | Example |
| Angle (°) of intersection | 115 | 117 | 120 | 125 | 128 | 108 | 128 |
| angle portion with rib edge | | | | | | | |
| Width (mm) of | 2.5 | 2.5 | 2.5 | 3 | 2.5 | 2.5 | 2.5 |
| runner groove | | | | | | | |
| Depth (mm) of | 2.5 | 2.5 | 2.5 | 2.5 | 2.5 | 2.5 | 2.5 |
| runner groove | | | | | | | |
| Depth (mm) of rib | 8 | 9 | 9 | 10 | 8 | 8 | 9 |
| center portion in sipe | | | | | | | |
| Depth (mm) of rib | 4 | 4 | 5 | 6 | 4 | 4 | 9 |
| edge side portion in sipe | | | | | | | |
| H&T Step (mm) | 0.6 | 0.8 | 1.1 | 1.5 | 1.8 | 0.5 | 2.1 |
| Wet Performance | 100 | 101 | 101 | 102 | 102 | 98 | 102 |
| Feeling Index | | | | | | | |

Table 1 shows that, in each of the pneumatic tires of Examples 1 to 6, H&T step is suppressed compared with the pneumatic tire of Comparative Example 1.

Moreover, Table 1 also shows that the pneumatic tires of Examples 1 to 6 can be safely turned and stopped on the wet road surface as in the case of the pneumatic tire of Comparative Example 1. Note that an assessment is made that the tire can be safely stopped if the index is 95 or higher.

From the above two tests, it is found out that, in the pneumatic tires of Examples 1 to 6, the H&T step amount is significantly suppressed while keeping approximately the same wet performance, compared with the pneumatic tire of Comparative Example 1.

### INDUSTRIAL APPLICABILITY

In the pneumatic tire according to the present invention, a plurality of sipes are formed in at least the two or more ribs so as to cut across the ribs. Moreover, in each of the divided ribs, the runner grooves communicated with the sipes are formed so as to cut across the ribs. Thus, the uneven wear can be made less likely to occur by sufficiently maintaining the circumferential rigidity of the divided rib while enhancing the edge effect and the drainage. Consequently, in the pneumatic tire, it is possible to improve uneven wear resistance while improving wet performance.

1. A pneumatic tire comprising:
a tread extending in a tire circumferential direction, wherein the tread includes
a plurality of ribs defined in a tire width direction by a plurality of circumferential main grooves formed so as to extend continuously in the tire circumferential direction and
a plurality of divided ribs divided in at least two of the plurality of ribs by a plurality of sipes formed in the at least two of the ribs in a traversing manner so as to be spaced apart in the tire circumferential direction,
only on one side in the tire circumferential direction in each of the divided ribs, a runner groove communicated with the corresponding sipe is formed so as to cut across the rib, and
all intersection angle portions on one side in the tire circumferential direction in each of the divided ribs have obtuse angles.

2. The pneumatic tire according to claim 1, wherein
among all the intersection angle portions, angles of the intersection angle portions with respect to rib edges are set to 110° to 125°.

3. The pneumatic tire according to claim 1, wherein
each of the sipes has an odd number of bent portions in the middle of crossing the rib.

4. The pneumatic tire according to claim 1, wherein
a depth of each runner groove is set to 2 mm to 4 mm and a width of each runner groove is set to 2 mm to 5 mm.

5. The pneumatic tire according to claim 1, wherein
in each sipe, a depth of a rib edge side portion is set smaller than a depth of a rib center portion.

6. The pneumatic tire according to claim 1, wherein
the depth of the rib edge side portion in each sipe is set larger within a range of 3 mm to 8 mm than the depth of each runner groove.
